(19) United States
(12) Patent Application Publication
(10) Pub. No.: US 2014/0258260 A1
(43) Pub. Date: Sep. 11, 2014

(54) METHODS FOR ON LINE DATING

(71) Applicant: Sabrina Rayborn, San Jose, CA (US)

(72) Inventor: Sabrina Rayborn, San Jose, CA (US)

(21) Appl. No.: 13/794,711

(22) Filed: Mar. 11, 2013

(51) Int. Cl. G06F 17/30

(52) U.S. Cl. CPC G06F 17/30864
USPC 707/707

(57) ABSTRACT

A dating search method includes extracting dating query information based on input from a user; pruning a list of dating sites based on which of the dating sites can provide a search result to a search request based on the query information to automatically generate a list of at least two dating sites to search; transmitting to at least two dating sites, a search request based on the query information, where each dating site is associated with a respective one of the pruned suppliers, and wherein each dating site performs a search and produces at least one search result; receiving, at least one search result from a first one of the dating sites and at least one search result from a second one of the dating sites; and incrementally transmitting the search results to the user, such that the search result from the first one of the dating sites which is received before the search result from the second one of the dating sites is presented to the user before the search result from the second one of the dating sites.

The present application relates to online dating.

### BACKGROUND

A variety of online dating services have been developed to take advantage of the extensive network capabilities of the Internet. Instead of providing localized exposure to the dating community through traditional means, such as newspapers or local bulletin boards, the Internet opens the pool of potential matches to a greater dating community and a much wider range of people. These online dating services find compatible matches for people based on a potentially large number of characteristics associated with each user.

Although these systems are often useful in finding suitable friends or dates for people, the process of coordinating the meeting of people through these systems is often quite cumbersome and must include special mechanisms to ensure the security and privacy of the users prior to their decision to meet. In this manner, present systems do not facilitate the spontaneous meeting of people, but instead require that both parties go through a potentially involved validation process or risk having their sensitive information simply disclosed to anyone who the system thinks may be compatible. Another disadvantage associated with present online dating services is that they do not account for the real-time location of the users. Although users can specify that they only wish to meet people who live in certain town or neighborhood, they do not actually take advantage of the instantaneous location of the people to facilitate the meeting of potentially matched people.

United States Patent Application 20070282621 discloses a mobile dating system utilizing a location-based social network manager process. The social network manager process is executed on a server computer coupled to a plurality of mobile communication devices over a wireless network. Each mobile device is a location-aware mobile communication device. U.S Patent No. 20130054693 discloses systems and methods for Automated Recommendations for Social Media.

U.S. Pat. No. 6,297,819 discloses World Wide Web browser extensions based on server processes rather than on plug-in program modules loaded and installed on a user's machine. U.S. Pat. No. 6,735,568 utilizes a pairwise “satisfaction index” derived from factors elicited through survey questions and empirical data analysis. U.S. Pat. No. 6,735,568 discloses a method to be performed by a computer for operating a matching service, comprising: generating, from empirical data, a number of factors corresponding to a like number of functions of one or more variables relevant to relationship satisfaction. U.S. Pat. No. 7,483,883 discloses a dynamic information connection engine. When the user is searching for supported information, information is extracted electronically from a plurality of third party web sites, direct supplier connections, and intermediate databases. Potential information suppliers are automatically selected in response to the detected user search.

### SUMMARY OF THE INVENTION

In one aspect, a dating search method includes extracting dating query information based on input from a user; pruning a list of dating sites based on which of the dating sites can provide a search result to a search request based on the query information to automatically generate a list of at least two dating sites to search; transmitting to at least two dating sites, a search request based on the query information, where each dating site is associated with a respective one of the pruned suppliers, and wherein each dating site performs a search and produces at least one search result; receiving, at least one search result from a first one of the dating sites and at least one search result from a second one of the dating sites; and incrementally transmitting the search results to the user, such that the search result from the first one of the dating sites which is received before the search result from the second one of the dating sites is presented to the user before the search result from the second one of the dating sites.

In another aspect, systems and methods are disclosed for an online dating search tool connects people with other people via specific search criteria and allows for communication and registration on other dating or social media websites. The method includes searching for a date, relationship or friend via multiple available dating and social networking websites. The system offers a more effective search tool that would allow an individual to search multiple websites at the same time for a date, relationship or friend. Upon doing a search of the “users” desired characteristics and traits, this website would return to the “user” a list of results drawn from multiple dating and social media network websites.

Advantages of the system may include one or more of the following. The system provides an effective method to find links to profiles of users on dating sites and social media pages for the purpose of finding a date, relationship or friend. The system increases visibility of various dating and social media networking sites. The use of templates simplifies the creation of user profiles. This would facilitate interaction with other users at various dating and social media sites. The system offers multiple “social media” website choices on a singular platform to people looking for date/relationships/friend. The system provides search results from multiple dating or social media networks in order to increase the effectiveness of finding a dates, relationship or friend. Links are provided to user profiles on more than one dating/social media network site at a time to in order to increase effectiveness of the user's dating results. Based on agreements with various social media websites, this system would allow the user to be linked to those websites that contain the results that match their search criteria, and would then allow the user access to those websites that contain the results of their search. The system provides a template for creating a temporary user profile when required.

### BRIEF DESCRIPTION OF THE DRAWINGS

Embodiments are illustrated by way of example and not limitation in the figures of the accompanying drawings, in which like references indicate similar elements and in which:

FIG. 1 shows an exemplary system that links users to various dating services.

FIG. 2 shows an exemplary process for performing a single query with multiple dating site matching.

FIG. 3 shows another exemplary process for performing a single query with multiple dating site matching.

FIG. 4 diagrams one exemplary user operation and information flow of an exemplary multi-dating-site search system.

FIG. 5 is a block diagram of a mobile communication and computer network that implements embodiments of a location-based social network system.

### DESCRIPTION

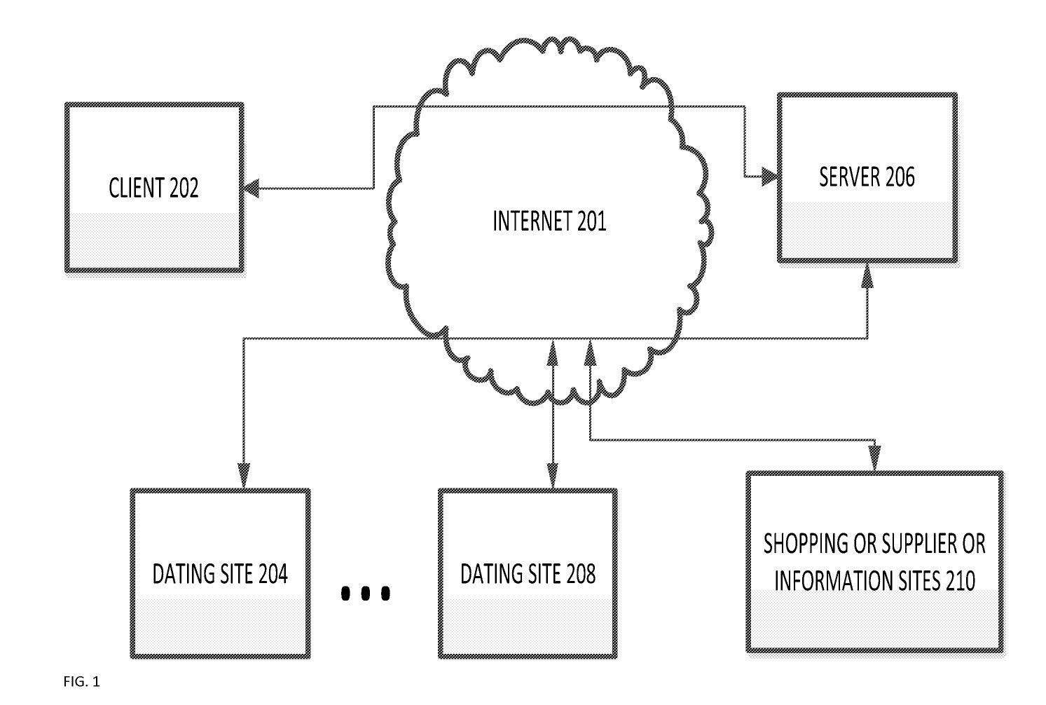

FIG. 1 shows an exemplary system that links users to various dating services. In the following description, numerous specific details are introduced to provide a thorough understanding of, and enabling description for, embodiments of the system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

Turning now to FIG. 1, a block diagram of a transaction system process flow 200 of an embodiment is shown. A user browses the Internet 201 using a client 202 or client computer. The user accesses a World Wide Web site supported by a server 206, and in one embodiment the site is a dating site. The server 206 in turn spawns requests for matching candidates from a plurality of dating sites 204-208. The sites 204-208 work in parallel (aggregation) and aggregate the results back to the server 206 over the Internet 201. Additionally, in one embodiment, the server 206 also receives matching results from shopping, supplier, or information sites 210 in order to shop for a prospective purchase that matches a date. For example, flower vendors or jewelry vendors may advertise on the site. Movie producer may want to run trailer ads on the site for the date. Addition, client software tracks the user's actions, reporting a subset of these actions to the system server 206, or server. The server 206 collects this information and retains it for future use. The server 206 also immediately analyzes the user action and, in response, makes electronic requests, or shadow requests, to product and information suppliers, to obtain relevant data. The shadow request communicates the key elements of the action being taken by the user. In response to the shadow requests, the server 206 receives responses from the various product and information suppliers available online. The server evaluates the responses and formulates a response for the user. The response is transmitted to the client 202.

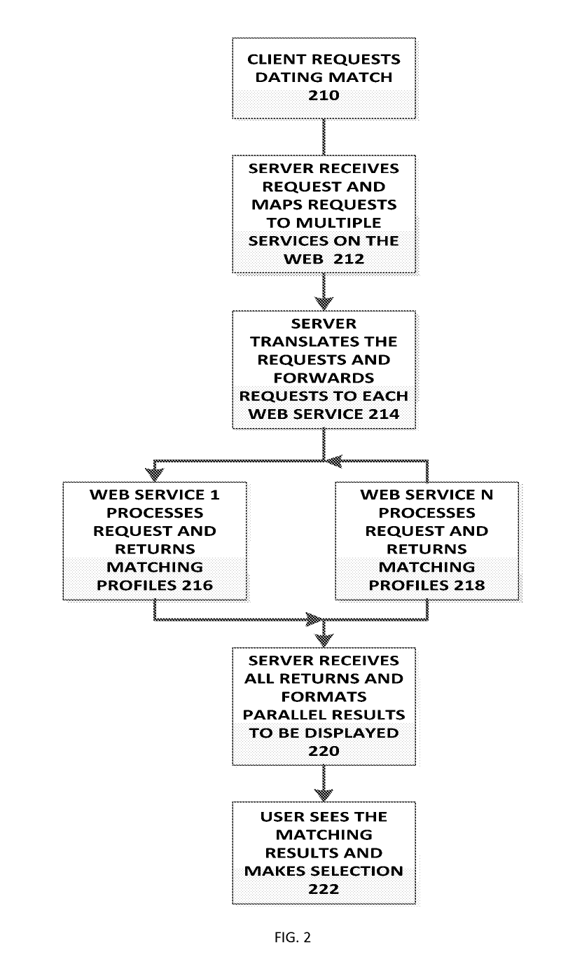

FIG. 2 shows an exemplary process for performing a single query with multiple dating site matching. In this process, a user enters information into a client (such as a thin client software), which requests potential dating candidates from server 206 (210). The server receives the request and maps the request to a plurality of dating services or sites on the Internet (212). The server then maps or translates the user's dating profiles or interests into each dating sites's Application Program Interface (API) and forwards the request to each web service (214). Each web service in turn processes the request and returns matching profiles in parallel (216-218). The results are aggregated and displayed for reviews (dating site aggregation). As the result comes in, the server formats the information for display to the client (220). The client or user reviews matching results and takes action as necessary to hook up with the candidate for a date (222).

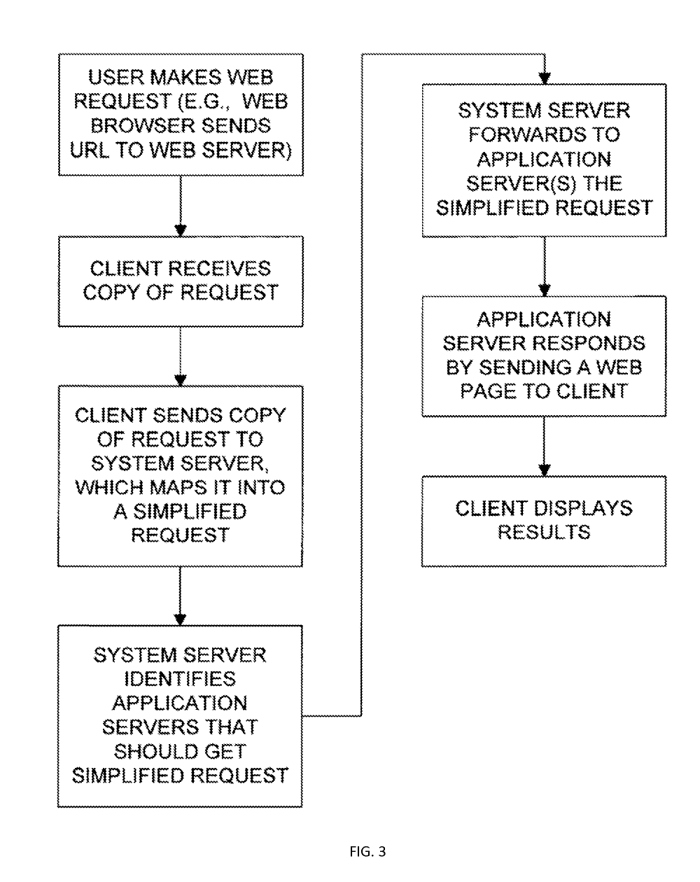

FIG. 3 shows another embodiment of FIG. 2. In this embodiment, the user makes a web request by sending a URL to the web server 206. The client software receives the request and send a copy of the request to the server 206, which maps the request into a simplified request through an API. The server identifies application servers on the internet that should get the simplified request, and forwards to the matching application server(s) the simplified request for matching dates. The application server responds by sending a link to a web page to the client and client displays the results.

The online dating component includes a separate profile page for each user who subscribes to the online dating service provided by the system. This profile page collects certain characteristics specific to the users dating preferences. The profile page specifies various item choices that the user feels might be relevant in determining compatibility with other users who might be interested in dating or establishing a relationship with the user. Some of the profile items within the user's personal profile include his or her profile name, birthday, gender, present relationship status, height, body type, hobbies and the like and a list of choice characteristics important to the users search. When utilizing the online dating system, each user can set up a specific user identifier that is different from the user's actual name or name used as part of the entire social network system. This user identifier basically comprises an alias (pseudonym) or dating name that provides a layer of anonymity and security for the user. In the profile page, the user can also specify whether he or she is interested in meeting other men or women, and the type of relationship they are seeking. One or more text blocks can be provided to list particular interests that the user might want to broadcast. This allows the system to perform keyword searches on like fields of the other user's profile pages to determine compatibility on the basis of specific user interests. Other text blocks, such as the status message text block, can be provided to allow the user to type in a specific status message relating to dating availability and preferences.

Satisfactory searching and matching of people in a dating or relationship context typically requires the identification of characteristics and match criteria across a broad set of data points. The online dating system also provides additional interface pages that allow the user to specify other personal characteristics in order to populate other dating web site pages. This profile page for an online dating system, under an embodiment can be provided for which the user can specify certain aspects about themselves they wish to share with users on other websites. These are accessible through menu bar, and include, but are not limited to, contact information, educational background, professional and career background, favorite things/places/activities, answers to interesting or key questions, pictures of the user, and so on. This information would go beyond just searching for physical characteristics of a user, but would allow the user to share more detailed information about themselves for matching purposes. These additional profile information pages would for example, allow the user to input text or graphic information relating to the user, such as specifying which high school/university the user attended, what kind of job the user currently has or wants to have, and so on. Other pages provide specific fields that allow the system to determine matches based on similar input by other users. A favorites profile page for an online dating system, under an embodiment can be provided for which the user can specify a particular favorite. These include favorite places to eat, dance, drink, hang out, shop, relax, and so on. Text fields can also be provided to allow the user to list specific favorites, such as books, movies, television shows, and so on. The fields of the favorites page allow the online dating service to compare and match entries with other users of the system in a one-to-one manner. Similarly, a “Questions” page can be provided to prompt the user to provide answers to several useful or provocative questions to allow other users to gain insight into the personality of the user.

The server 206 can work with social network dating system as well as conventional dating sites such as match.com. In one embodiment, the online dating component can be activated and deactivated as a separate program within the location-based social network manager process. Likewise, a user's dating profile is defined and kept separate from his or her general profile, and is not accessible to other friends or users in the network, unless they are also engaged in the dating system and are compatible with the user. This allows the user to find other users strictly on the basis of dating preferences, rather than general friend or event preferences, and allows the user to specify and broadcast personal information to others for the purpose of entering specific types of relationships, rather than general activities. For this embodiment, the social network manager process provides a specific online dating interface page that allows the user to set the dating mode and specify search criteria for the system to perform searches. The dating service matches the user with potential dates in the vicinity of the user based on the users dating profile. In one embodiment, the user receives an alert on his or her mobile communication device when a match is detected to be nearby. The dating profile relating to the user can then be accessed by these potential dates so that they can decide whether or not they would like to meet the user.

In one embodiment, the online dating component of a location-based social network manager process includes a matching program that receives the dating profile information for users and determines suitable matches based on certain correlation algorithms. The online dating component then determines the relative proximity of matched users to one another. In this manner, only potential matches who are within a certain distance to a user are registered as actual matches. The server computer transmits an alert or similar notification to the user of any matches within this radius.

In one embodiment, the online dating component includes a database lookup process and a comparison module that identifies eligible dating users within a group of users and then performs a matching function to find potential matches for each requesting user. The database lookup process first determines which users that are currently logged into the system or accessing the server have their dating mode option turned. It then looks through the personal profiles for each of these users and compares each relevant profile data object with corresponding fields in the other active dating users' preference pages. Secondary match criteria can be based on entries provided in the favorites page, questions page, and the like. Users who do not meet the criteria specified by the requesting user are filtered out by the system, and users who do meet the match criteria are either flagged or stored in a separate database. The location monitoring function of the location-based social network manager process tracks the relative location of the requesting user and any potential matched users. When any of these users enters the radius specified by the user or defined by the system, the process sends a notification to the user's mobile communication device.

To protect the security and privacy of each potential matching user, the online dating component does not allow precise location information of a potential match to be sent to other users of the system, and it does not allow his or her contact information to be sent to the searching user. The system can also block the display of the potential matches location on the mobile communication device of the searching user. In one embodiment, when a match is found, the user is alerted that a match within a certain distance is present. The alert message instructs the user to log into the server to obtain further background information about the potential match. This background information can include a picture and profile information about the potential match. The user can then initiate a communication through the server to the potential match. Thus, the system provides means to facilitate communication to the matched users, but does not provide identifying information directly to the user. For example, clicking on an icon of a matched user allows the user to send a message to the matched user to open a dialog or even set up a meeting. Thus, in one embodiment, if the user opts to contact any of the potential matches within this radius, he or she sends a notification message to the server. The server then routes this request to the appropriate matched user, who can then send a response back through the system to the requesting user. Transmission at this level is performed without either user knowing the actual identity of the other user. Once a dialog is established, the users can trade personal information and exact location, or they can continue to use the server as a communication proxy. For example, the server can be configured to send an anonymous call to both the searching user and the potential match. This call can alert the users to contact each other or set up a direct call between them when they log onto the server.

In general, once both users have established contact and mutually agreed to meet, they can enable the display of their location information on the device display of the other user to facilitate locating each other and setting up a meeting. For applications in which absolute location security is not required, the server can be configured to display a rough location for the potential match on the communication device of the searching user, or display a place of interest that is near both users so they can meet at a convenient location if both parties agree.

For the mobile dating embodiments, a revenue model may include charging a fee for the users to send anonymous messages to potential matches, or charging a membership surcharge to use the mobile dating service.

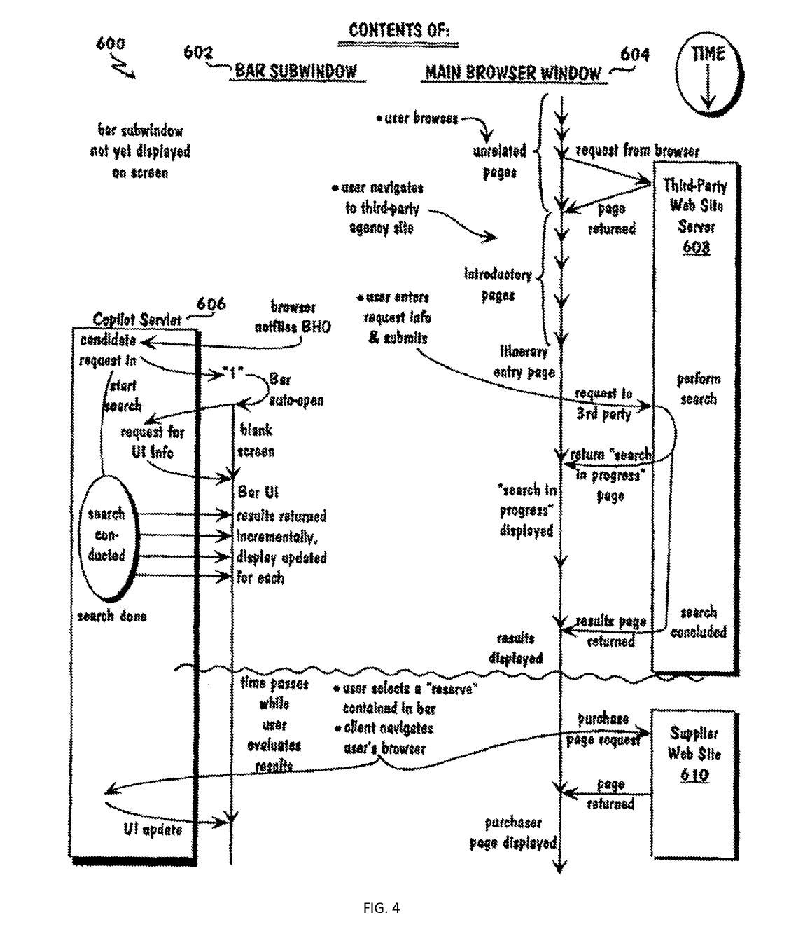

FIG. 4 diagrams one exemplary user operation and information flow 600 of a multi-dating-site search system of an embodiment. In this embodiment, a client application running on a Windows computer interacts with a server 606. The information is transferred among a Bar sub-window 602 and a browser window 604 of a client computer, at least one component of a server system 606, at least a plurality of third party dating servers 608, and at least one supplier web site 610. At the highest level, the transaction system locates and presents information relevant to a user request. In an embodiment, user requests include the desired dating characteristics, and the information returned includes matching candidates or alternatives that meet the requirements of the user. Users of the system looking for a date and would require a user profile template (depending on the social media it links). For example, if the user is searching for a date with blue eyes, black hair, lives in Sacramento and is Christian, the user may be linked to a website that does or does not require a user profile. Either way, the user would get links to individual profiles on various dating and social media networks that fit the users search criteria. If the user needs a profile, the system would generate one for that particular dating or social website.

In an embodiment, the general flow of processing for each request or itinerary begins when the user enters candidate information through the client user interface or through a dating-entry page of a web site. The dating information is transferred from the client to the server. The server reviews the dating information and determines matching candidates. The server couples to the appropriate systems of selected dating systems and makes queries about the available candidates matching the user intent or user request. The couplings to dating services and suppliers can be made numerous ways including, but not limited to, requesting pages from their web sites and extracting information from the pages and using a connection intended solely for inquiries from the search system. The server returns boiler-plate data display and formatting information to the client. As results are received from each queried dating site, they are evaluated and processed for possible transmission to the client along with search progress status information. When all results have been received from the queried dating sites, final “search complete” status information is sent to the client.

The transaction system of an embodiment automatically detects and interprets user requests for relevant types of information. In contrast, most existing information search systems require the user to explicitly provide their request to the system, typically by entering information into a web page. While this is also an option in the transaction system, the transaction system is also capable of detecting other user actions and interpreting them as implicit requests for information.

When examining user actions to determine if a search operation can be started, information is accumulated from a sequence of actions up through a final trigger event. For example, if a user has entered information on a web page, or in a sequence of successive web pages, the triggering event might be the activation of a submit-type control on the final page. However, the system can use all of the entered information to determine if the final user action (submit) should be used to start a search.

However, this example is neither the least nor most complicated instance of monitoring user actions that might be used in the system. Other examples of user actions/input that might be used include, but are not limited to: detection of the selection of a single control or sequence of controls that indicate an interest in a supported type of information; entry of information by the user in a control or sequence of controls; entry of information through natural-language or N-gram techniques; selection of a pre-existing set of information as identifying the user's interest. It should also be noted that while most contemporary client systems are computer systems in which the user provides input through typing and/or pointing devices, any means of user input may be used with the search system including, but not limited to, handwriting recognition and voice recognition.

It is also noted that all methods for monitoring and evaluating user input may be applied to both user actions performed with respect to a third-party web site as well as an interface of the client system or web page maintained by the search system operator.

The monitoring of user activity, in an attempt to recognize actions that indicate a desire for the type of information that the system has been implemented to collect and present, is accomplished hierarchically, but is not so limited. The client is primarily responsible for monitoring user actions. The primary mechanism for this monitoring is capturing the user web browser requests for new pages, although other mechanisms could be used to achieve the same result or slightly different results for implementations designed to search for other types of information. The monitoring is accomplished through a Component Object Model (COM) interface. This interface captures each URL, or navigate event, that the browser is about to fetch.

The first step in determining if the user is trying to find information about travel alternatives is to compare the root portion of the URL with a list of strings maintained by the client. This list is stored in the Windows registry, a system database of configuration information, and can be updated by the server when it is out of date.

When a URL requested by the browser matches one of the partial URL strings stored by the client, the client forwards it (and possibly the associated data if the user's browser is making a POST request) to the Servlet portion of the server for further processing. The server determines if a particular user request is a request for dating information and contains enough information to be considered a “dating request” that can be used for a search. While the simple string comparison against the URL is adequate for the needs of the travel-information searches, other embodiments may use a different first-level analysis of user operations, as determined by the complexity of the information needed to perform the search.

The transaction system also accommodates a user providing their request directly to the system with the entry of dating profile information into a web page. With this entry method, the user enters dating profile information directly into the HTML form that is part of the client user interface. This is possible either when the user has opened the Bar explicitly or after it has automatically opened in response to a previous user action/input.

In general, a session starts the first time after the client has stated a need to contact the server, and continues either until one of the systems timeout periods expires or until the user takes an explicit action that shuts down the client. The installation of an embodiment comprises several operations that generally occur the first time the client starts after it has been installed and/or the first time a new client installation connects to the server. In particular, when first installed on a system the client creates a GUID to serve as the client's permanent ID number. It is noted that the User ID (UID) is actually specific to a particular operating system installation rather than to an actual individual user.

The client attempts to make a connection to the server, starting a logical “session”, only after it reaches a point where it needs information from the server in order to continue. The two cases in which this occurs are: the user explicitly opens the Bar causing the client to need the HTML/JavaScript source for the user interface to be displayed; and, the client detects the browser attempting to load from a URL that is a candidate for containing an itinerary, in which case the URL (and possibly associated POST data) must be sent to the server for further analysis.

As an optimization, the software checks for the existence of a connection from the client system to the Internet or other coupled network before attempting to communicate with the server. Since attempts to communicate with the server would fail in this condition anyway, this check prevents wasted processing and error-recovery.

The UID is not required to be strictly permanent. In an embodiment, the UID is stored in the Windows registry (a system database of configuration information) and therefore subject to accidental or intentional deletion. Each time the client starts execution, it checks for a UID in the registry, and if one is not present it creates one. It is this portion of the client that creates the UID after the initial installation so that installation is not actually handled as a special case. In the event that a client UID is destroyed and the client allocates another one, the only aspects of the system that are impacted are: the ability to correlate user operations performed with the old UID and those performed with the new UID; and, the ability to retrieve the user's previously selected/specified personalization options.

In the preferred embodiment, if the user provides personal information through the registration web page during the installation process, the client forwards it to the Servlet when it initiates contact. The server database records keyed by the UID also contain user personal information. This information can be manipulated by the user through the user interface presented in the Bar.

Personal information is used to control different aspects of the client behavior and of the server behavior toward a particular user. For example, the personal information controls whether a software client will be automatically updated if a newer client version is available. It can also be used to guide the information search performed by the server. For example, in the preferred embodiment where searches are performed for available dates, the personal information can contain things like age, sex, sex orientation, race, hair color, eye color, height, favorite activities, career, and other information that results in the availability of matching dating candidates.

In coupling to the server, a client creates a session identifier (SID). This is another 128-bit, universally-unique identifier. The SID is transferred in all future transmissions from the client that are part of the same session. The SID allows the server to distinguish semi-simultaneous requests made by different clients and between requests originating from different browser windows on the same client.

The first exchange between the client and server in a session is when the client performs an HTTP POST transaction with a destination URL that specifies the Start Servlet. This POST transaction transmits data including the UID, the SID, the personal information provided by the user (if it has not been previously transmitted), and the client's current version number.

In response to this POST, the Start Servlet returns several pieces of information including the version number of the latest client release, the version number of the lists of partial-URL strings stored by the client, and those items from the personal information associated with the transmitted UID that affect client operation. If the version number of the latest client release is larger (later) than the receiving client version number and the user has elected to receive client updates, the client undertakes downloading and installing the latest client version in parallel with subsequent primary operations. If the version number of the lists of partial-URL strings is larger (later) than the receiving client version number, the client downloads new copies of the out of date lists. These lists are used by the client to determine which URLs are candidates for itineraries and are to be forwarded to the server, and which URLs indicate the completion of a purchase by the user.

The Servlet also performs several internal housekeeping functions. It verifies that the supplied UID already has a matching record in the server database, and creates a record if it does not. It also creates a “Session Info” object which will persist on the server for as long as the session remains active.

In the embodiment of FIG. 4, the client is implemented as a set of COM objects that are packaged together in a single Windows DLL for installation and use. There are three primary COM objects (objects that are assigned COM GUIDs and registered in the Windows registry) that make up the client: the Browser Helper Object (BHO); the Bar object; and, the installation object. The division of the client into these primary objects and the different minor (non-COM) objects is an artifact of restrictions imposed by the architectures of IE, COM, and ActiveX and has nothing to do with the underlying architecture or functions of the client. The BHO is created to extend IE. When IE first initializes, IE searches a known area of the Windows registry for the GUIDs of registered BHOs. Internet Explorer creates an instance of each BHO that it finds, which includes the search system client BHO. When the BHO is created it couples to different portions of IE's COM interfaces so that it is notified of the user actions that must be monitored to determine if the Bar should automatically be opened. After this initialization, the BHO monitors user actions until IE is terminated and the BHO is destroyed. Unless the BHO observes a match between a URL being requested by IE and one of the entries on the URL list, no other actions are taken. Another task of the BHO is to manipulate the Bar object based on feedback from requests submitted to the server. For example, if the BHO observes a match between a URL the IE is requesting and the URL list, it opens a new session (if not previously accomplished) and forwards the requested URL to the Copilot Servlet for further checking. If the Copilot Servlet returns a “1” string, indicating that it has started a search, the BHO creates a Bar object and opens the Bar sub-window on the screen if it is not already visible. Further, alternate embodiments can implement other return codes or strings that result in other types of actions. After this, the BHO receives a URL that references the client's assigned (via load balancing) front-end server. The BHO uses the COM interface with the Bar to cause the Bar to load from the specified URL, which gives the Copilot Servlet the opportunity to transmit the HTML and JavaScript that form the client user interface. Subsequently, each time a new set of content must be sent asynchronously from the server (e.g., not at the request of the user or the JavaScript executing within the Bar) the BHO will again cause the Bar to navigate to the new, server-supplied URL. Additionally, with the help of the Bar, the BHO is responsible for implementing the client-side session time out counter. The BHO maintains the counter, resets it when it detects relevant user activity (based on IE's navigating to new URLs at user requests), transmits the end-of-session message to the server when the counter expires, and receives “reset counter” messages from the Bar when the Bar detects user activity (such as manipulating controls within the HTML user interface displayed by the Bar) of which the BHO is not directly informed. As part of managing the session time out, the BHO also periodically provides messages to the Copilot Servlet informing it that the session is still in active use by the user. This prevents the server from timing out the session in the case where the user is performing actions that are entirely local to the client or that involve only a third-party or supplier web site and which, therefore, do not cause the client to send requests to the system server.

The server 206 of FIG. 1 can also work with a location-based social network system and mobile communication device that incorporates a real-time map display. The social network manager process is executed on a server computer coupled to a plurality of mobile communication devices over a wireless network. Each mobile device is a location-aware mobile communication device. The process determines the geographic location of a mobile communication device operated by a user within an area, displays a map representation of the area around the mobile communication device on a graphical user interface of the mobile communication device, and superimposes on the map the respective locations of one or more other users of mobile communication devices coupled to the mobile communication device over the network. The user specifies a personal profile that includes information relating to the user that is pertinent to comparisons with other users in the system. The user also specifies preferences relevant to the type of person and/or relationship the user would like to find. The system includes a matching process that compares the dating information for the users within the system to determine whether any matches are within a preset radius of the user. When any matches are within the proximity of a user, the system sends an alert message to the user. The user then logs onto the server system to obtain background and contact information for the prospective match or matches, and can then initiate communication with matches within the area.

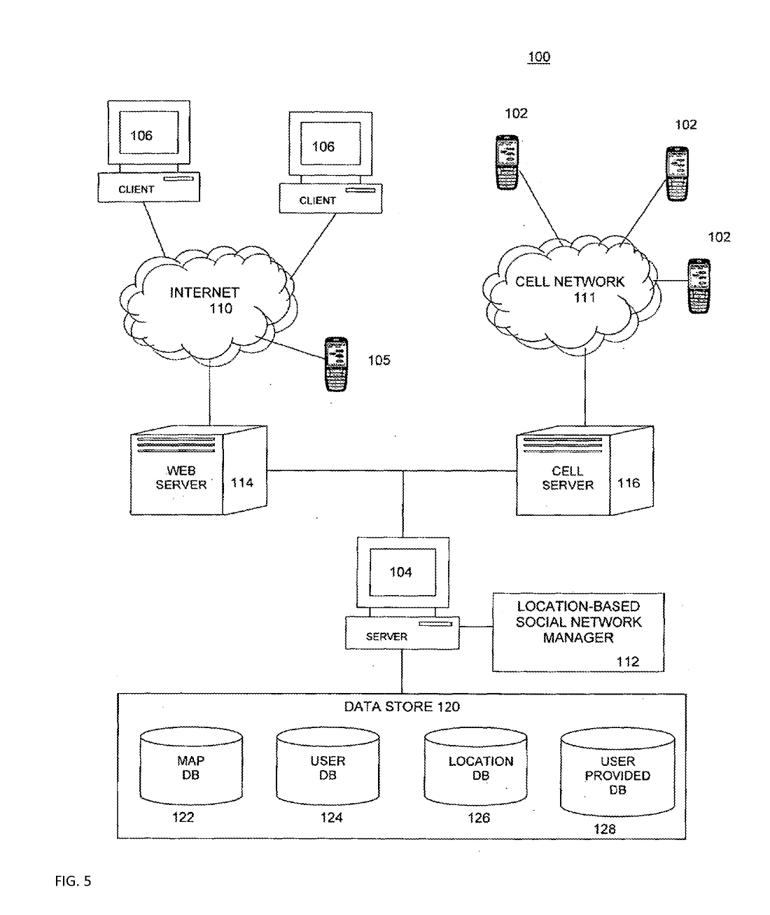

Embodiments are directed to a location-based social network system that enables the display of maps and real-time location information on mobile phones and similar communication devices. FIG. 5 illustrates a communication and computer network system 100 that implements one or more social network based embodiments that provide information to the server 206. In system 100, a plurality of mobile communication devices, such as cell phones or similar devices 102 are coupled to a communication network, such as cell network 111. The mobile communication devices (or “mobile devices”) are each carried and operated by a user and communicate with one another using known communication methods such as wireless telephony, radio, satellite, cellular systems (e.g., GSM, CDMA, and so on), or other similar systems. For the embodiment exemplified by FIG. 5, the mobile communication devices are cellular phones and the network coupling these devices is a cellular telephone network, although it should be noted that any other type of wireless network that supports mobile devices can also be used.

In one embodiment, a server computer 104 runs a location-based social network manager process 112. This process controls various data objects relating to one or more social parameters or characteristics of the users of the mobile devices 102. The users of the mobile devices form a group or number of subgroups of people who desire to interact with one another on a social level by communicating with one another, participating in activities, sharing information or experiences, or other types of social or professional interaction based on their location. Because the users of the mobile devices are inherently transitory, a fundamental data object associated with each of the users of the mobile devices is the location of each user within a particular region. Other parameters include the profile of each user, and the preferences of each user with respect to activities, people, privileges, and so on. Each user who desires to interact with other users in the system using this data utilizes the location-based social network manager process 112. Through a subscription, or similar membership-type (free or fee-based) participation model, each user registers with the server computer 104 by providing certain information relating to the user. Each principle parameter or characteristic for each user is stored in one or more databases accessible to the server computer 104. For the embodiment of FIG. 5, the data objects are stored in a data store 120 and are organized in databases for user profiles 124, user locations 126, user provided data 128, and map tiles 122. The mobile network 111 supporting the mobile devices 102 are coupled to the server computer through an intermediate server computer, such as cell server 116.

In one embodiment, each user of a mobile device may also operate or access the location-based social network manager process 112 through a client computer 106, or any device that can access the Internet, such as a WAP (Wireless Application Protocol) device 105. The client computer 106, or similar device 105 (hereinafter also referred to as a “client computer”), facilitates the establishment and management of each user's account on the server computer by providing a comprehensive interface to the databases and processes provided on the server computer 104. For the embodiment shown, the client computer interface supported by the server computer is a World-Wide Web (WWW) based interface through a web server 114 to the network 110 that supports the client computers 106. Thus, for this embodiment, the web server 114 is a server or process that stores data in the form of web pages and transmits these pages as Hypertext Markup Language (HTML) files over the Internet 110 to the client computers 106. For this embodiment, the client computers typically run a web browser program to access the web pages served by the web server 114 and any available content provider or supplemental server that may also be coupled to the network. The client computers may access the Internet 110 through an Internet Service Provider (ISP). It should be noted that network 110 may be the Internet, a Wide Area Network (WAN), a Local Area Network (LAN), or any combination thereof.

As shown in FIG. 5, aspects of the one or more embodiments described herein may be implemented on one or more computing devices executing software instructions. The server computer 104 is typically a server or workstation class computer, but can be any type of computing device with sufficient power and resources. The client computer 106 or 105 can be any type of personal computing devices, such as a workstation, personal computer, notebook computer, mobile communication device, game console, camera, personal digital assistant (PDA), or any device with an appropriate amount of processing capability. Likewise, each mobile device 102 can be a mobile computing device, such as a mobile phone, PDA, notebook computer, game console, or any similar class of mobile computing device with sufficient processing and communication capability to interact with other devices over network 111.

As shown in FIG. 5, server computer 104 runs a server-side location-based social network manager process 112. The client computers 106 may run a client side version of this program, or they may access executable program components over the network 110, such as through web browser. Data for any of the clients 106 or mobile devices 102 may be provided by a data store 120 that is closely or loosely coupled to any of the server 104 and/or each network 110 and 111. A separate content provider computer may provide some of the data that is associated with the social network manager program 112. Although data store 120 is shown coupled to the network server 104, it should be noted that content data may be stored in or more data stores coupled to any of the computers of the network, such as a network client 106 or to devices within the network 110 itself.

In one embodiment, the location-based social network manager process 112 contains one or more program components that perform the tasks of displaying location and user profile information related to each mobile communication device that is part of the network, on each mobile device and client computer, and facilitating communication between devices based on the location information. The process also includes a database manager program that manages the different databases stored in data store 120. It should be noted that the various databases 122 to 128 shown in data store 120 can be organized as separate databases, portions of a single database, or any other logical structure appropriate for storing the data.

As illustrated in FIG. 5, data store 120 stores user information in user database 124. This information relates to each user of a mobile device 102 and includes basic information, such as the user's name, identifier (nickname or “uid”), security check information (e.g., date of birth, mother's maiden name), and so on. Depending on the social network services provided by the system, this database can also store the user's social and consumer preference information, such as what type of people the user is interested in meeting or dating, what types of food or events the user prefers, and so on. The user provided database 128 stores graphic information related to each user, such as the user's picture, and any other associated images. These images can be displayed on the other user's mobile devices to provide a visual reference for each user. The user provided database can also store other data objects, such as video clips, audio clips, hypertext links, documents, or other data provided by or associated with the user. Location information for each user, such as location histories, frequently visited areas, and so on, is stored in the location database 126. A map database 122 can also be included. This database provides the background maps that are displayed on each user's mobile device and correspond to an area or region around the user at the time the user invokes the process. In one embodiment, the map images comprise map tiles that are image files of maps with varying degrees of granularity. For example, a map tile of the United States may provide an image of the continental U.S. that can be zoomed to display a regional street level map for any area in the U.S. The maps may be stored locally within the data store 120 to be provided by the server 104 to the appropriate mobile device 102, or they may be provided by a third party map provider. Other databases storing information relating to the user's of the system and the areas of their operation can also be included in data store 120, such as an events database, a place of interest database, a store finder database, and the like.

In one embodiment, each user of a mobile device 102 maintains an account on the server computer 104 that is set up and maintained through a subscription or similar membership mechanism. This account allows each user to define their own profile and preference data and define the boundaries of interaction with the other users in the system. The server computer 104 may be a centralized server or cluster of server computers that maintains the processes and databases for a number of different users, or it may represent a distributed set of computers located in different geographic regions, each serving a different group of users.

The location-based social network manager allows each user to set up virtual networks that connect that user to other people, places, and events in a manner that adaptively utilizes the geographic location information for each of these items. The process 112 utilizes the user profile and preference information to allow the user to define networks of friends within the entire group of users and then locate these friends on maps that are displayed on the mobile device itself. Using the messaging and calendar functions of the mobile device, the user can then send and receive messages on the device from these friends, or find places of interest or events in the area.

In one embodiment, each mobile communication device runs local client versions of the map generator and database manager components. Such a component or components may be a thin-client program, such as a Java program running on a cell phone, for example. In one embodiment, each mobile communication device includes a circuit or component that determines the geographic location of the device relative to a standard set of coordinates. Such a location determination component can be a GPS module or assisted GPS (A-GPS) that provides the location of the mobile communication devices in terms of latitude/longitude coordinates, or a cell phone locator module that provides the location in terms of distance to the nearest fixed cell transmitter location or a group of transmitters, or other similar location determination method. Such methods can include, but are not limited to: Time-of-Arrival (TOA), Time-Difference-of-Arrival (TDOA), a Wireless Fidelity (WiFi) network, mesh networks, and similar networks. The client side map generator displays a map of an area (provided by map database 122) around the user on the display screen of the mobile communication device. Superimposed on this map is an indicator for the location of the mobile communication device. As the user moves, the position of his location on the displayed map is updated in real-time or near real-time. The map image information is configurable depending upon the location of the user, and can be provided by the server computer 104, a separate map provider service, or it can be programmed into the mobile device itself.

In one embodiment, the client-side database manager component stores information relating to acquaintances, friends, family, or other contacts (hereinafter collectively referred to as “friends”), as well as other items of interest, such as places of interest or locations of events of interest. The map generator component can be configured to display the locations of such items of interest or of any friends that are within the region displayed on the map, and have mobile devices that are similarly capable of determining their own location. In this manner, the user of the mobile communication device can see his or her location relative to other friends or places of interest directly on map displayed on the mobile communication device. In general, the displayed map is a street level map to aid the navigation of the user within the region displayed by the map. The map can be scaled from any number of degrees of resolution, such as from country to state or city level down to block level, depending upon the configuration of the map generator component.

The mobile communication device can also be configured to provide other functions or utilities that facilitate user interaction with friends based on the location information displayed on the mobile communication device. For example, a messaging utility can be used to send and receive text or voice messages from a friend or groups of friends within a displayed area. In one embodiment, the location-based social network manager process includes a messaging module that allows messages to be sent to friends on the device where they are most likely to see it. The messaging module utilizes the group module and the geographic location functionality of the mobile communication device. The message can be sent as a text message or instant message (IM) between mobile communication devices, or as a web message between client computers. In general, messages can be transmitted between any of the computers and devices illustrated in FIG. 5, thus, messages can go from mobile to mobile, web to web or mobile to web.

In one embodiment, the social network manager also includes an event manager module that allows a user to program places and/or events of interest. The event manager allows the user to create and manage various events using date and location information and send invitations or messages regarding the events to friends using the grouping function and messaging utilities of the system. Thus, the event manager module utilizes the group module and the geographic location functionality of the mobile communication device. Lists of public events can be provided by separate event servers accessible to the server, client computers or mobile devices of the system 100, or they may be programmed into an event database stored in data store 120. Typically private events are created and stored by each user, and each user may store events or other similar information in their own user provided database. Alternatively, events can be stored in one or more separate event databases (public and/or private events) within database store 120. If permission is granted, the database functionality of the mobile devices allows a user to view events created by other users or those that are public. Public events are typically events that are provided by users or partners that provide event information.

In one embodiment, the location-based social network manager includes a review and recommendation function that allows each user to review and rank events or places of interest so that this information can be shared with the other users. When a user visits a tagged POI (or attends a tagged event), he or she can provide a numerical (keypad) ranking of 1-9 and/or write a short summary of the place. The server process can also be configured to automatically request or remind the user to provide a ranking or summary of the POI upon the user's next system login through the web site or the mobile communication device. For each POI, the server compiles the rankings and summary reports and makes these available to any user who desires to see them. The server process can also be configured to compile statistical profiles or qualitative profiles of different tagged places of interest once enough ranking or summary information is available.

The server process can also include a machine learning component that can provide personalized ranking and reviews for individual users based on the identity of the reviewers. This process includes a Bayesian trust network component that learns each user's trust levels with respect to the other user's. Each user may trust certain of their friends with respect to certain types of places of interest. In this case, the system will weigh the ranking provided to the user based on the identity of the reviewer if the reviewer opinion is particularly trusted with respect to the tagged POI. In this manner, personalized and dynamic ranking and review profiles can be established for each POI based on the users and reviewers.

In one embodiment, an auto messaging mechanism sends an alert to a user based on the POI of another user. For this embodiment, when the user tags a particular POI, the server sends an alert to that user when a friend of the user gets within a certain distance of the POI. In this manner, the user can call, send a message, or arrange to meet with his or her friend at the POI, without needing to go through the trouble of pre-arranging a meeting. This facilitates spontaneous networking among users and their friends at particular places of interest. It should be noted that places of interest can be any type of location, such as retail establishment (store, restaurant, club, theater, gas station etc.), building (office, house, etc.), public resource (library, museum), street corner, object (e.g., ATM kiosk, post box), and the like Several interactive network features are facilitated through the use of the location determination and message capabilities of the mobile devices. For example, not only can friend locations be displayed on a user's mobile device, but an alert function can provide a graphic or audible alert to the user when a particular friend has entered a user determined area or region around the user. FIG. 9 illustrates an example of an alert function for the location-based social network manager process, under an embodiment. The user can specify a radius 906 around which he or she should be notified if a friend enters. The server computer then performs a periodic comparison of the user's location compared to that of his or her friends to determine if any of the user's friends are within this specified radius. The user location and radius are displayed on map 904. When a friend enters this radius, as determined by the server computer, a message is sent from the server to the user over network link 908 and displayed on the user's mobile device 902. The alert function can also be used to facilitate other interactive features, such as displaying or alerting the user to the location of places of interest in the displayed area or the time and location of events of interest when the user enters a particular area.

For an embodiment in which the network 110 is a cellular phone network, and the mobile communication devices are cellular phones or cell based communication devices, the device location module is a cell ID positioning program that determines the location of the device relative to the nearest one or more cell transmitters to determine a location fix of the device. Depending upon the capabilities of the system, location accuracy can be provided on the order of one to two hundred meters to actual location. If accuracy is not sufficient, the user can be provided with their approximate location either through map or text display and then input their actual location using street address, point of interest, or latitude longitude information.

In one embodiment, the location determination module is a GPS (global positioning system) circuit that determines the location of the mobile communication device using GPS methodology. GPS circuits are capable of updating a device's location on a real or near real-time basis. However, such continuous updates can impose a great deal of processing and communications overhead on the device and the network. Moreover, for a device that is capable of displaying the location of any number of other users, such continuous update methods are highly impractical. If the actual location of every friend in a network were required to be determined every time the user brought up a map, the time and cost requirements would likely be excessive. For embodiments in which the communication network comprises a cellular phone network and the mobile devices are cell phones, the location determination module may be an assisted GPS or “A-GPS” module that uses an assistance server and cell tower that helps the GPS receiver in the phone perform tasks of range measurements and position solutions.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the dating process is not intended to be exhaustive or to limit the embodiments to the precise form or instructions disclosed. While specific embodiments of, and examples for, the process and system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the dating system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the dating system are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A dating search method, comprising:
extracting dating query information based on input from a user;
pruning a list of dating sites based on which of the dating sites can provide a search result to a search request based on the query information to automatically generate a list of at least two dating sites to search;
transmitting to at least two dating sites, a search request based on the query information, where each dating site is associated with a respective one of the pruned suppliers, and wherein each dating site performs a search and produces at least one search result;
receiving, at least one search result from a first one of the dating sites and at least one search result from a second one of the dating sites; and incrementally transmitting the search results to the user, such that the search result from the first one of the dating sites which is received before the search result from the second one of the dating sites is presented to the user before the search result from the second one of the dating sites.

2. The method of claim 1, comprising searching for a date, relationship or friend through multiple available dating and social networking websites.

3. The method of claim 1, comprising searching multiple websites at the same time for a date, relationship or friend.

4. The method of claim 1, comprising searching for desired characteristics and traits, and returning a list of results drawn from multiple dating and social media network websites.

5. The method of claim 1, comprising providing links to user profiles on more than one dating/social media network site at a time in order to increase effectiveness of dating results.

6. The method of claim 1, comprising linking a user to be linked to websites that contain the results that match one or more search criteria, and then allowing the user access to the websites that contain the results of their search.

7. The method of claim 1, comprising providing a template for creating a temporary user profile when required.

8. The method of claim 1, comprising providing user information extracted from the temporary user profile to populate other dating websites that host searched results when required.

9. The method of claim 1, wherein the search results from the second one of the dating sites is added to a presentation representation which includes the search result from the first one of the searched dating sites.

10. The method of claim 1, wherein the search results are incrementally transmitted to the user as the search result are received.

11. The method of claim 1, further comprising filtering the received search results to select at least a portion of the search results to be transmitted to the user based on the input from the user.

12. The method of claim 10, wherein the filtering comprises assigning a score to each search result and not transmitting to the user each search result having an assigned score below a first threshold.

13. The method of claim 11, wherein the filtering comprises transmitting to the user, upon being received, each search result having an assigned score above a second threshold.

14. The method of claim 1, wherein transmitting to at least two dating sites a search request produces a plurality of search results from each of the dating sites.

15. The method of claim 1, wherein at least one of the extracting, pruning, transmitting, and receiving is performed in real time.

16. A computer system, comprising:
a processor; and
computer readable code executed by the processor for:
extracting dating query information based on input from a user;
pruning a list of dating sites based on which of the dating sites can provide a search result to a search request based on the query information to automatically generate a list of at least two dating sites to search;
transmitting to at least two dating sites, a search request based on the query information, where each dating site is associated with a respective one of the pruned suppliers, and wherein each dating site performs a search and produces at least one search result;
receiving, at least one search result from a first one of the dating sites and at least one search result from a second one of the dating sites; and
incrementally transmitting the search results to the user, such that the search result from the first one of the dating sites which is received before the search result from the second one of the dating sites is presented to the user before the search result from the second one of the dating sites.

17. The system of claim 15, comprising searching for a date, relationship or friend through multiple available dating and social networking websites.

18. The system of claim 15, comprising searching multiple websites at the same time for a date, relationship or friend.

19. The system of claim 15, comprising searching for desired characteristics and traits, and returning a list of results drawn from multiple dating and social media network websites.

20. The system of claim 15, comprising linking a user to websites containing results that match one or more search criteria, and then allowing the user access to the websites that contain the results of the search.
